(19) United States
(12) Patent Application Publication
(10) Pub. No.: US 2026/0100105 A1
(43) Pub. Date: Apr. 9, 2026

(54) GAMING CYCLE FOR PACHISLOT MACHINE

(71) Applicant: Amuse d.o.o., Ljubljana (SI)

(72) Inventors: Keiichi KOJIMA, Setagaya (JP); Satoshi JOKO, Sagamihara (JP)

(21) Appl. No.: 19/346,780

(22) Filed: Oct. 1, 2025

Related U.S. Application Data
(60) Provisional application No. 63/703,460, filed on Oct. 4, 2024.

(51) Int. Cl. G07F 17/32

(52) U.S. Cl. CPC G07F 17/3269; G07F 17/3213; G07F 17/3267

(57) ABSTRACT

Pachislot gaming systems, methods, and apparatuses are disclosed. A pachislot gaming apparatus may include a communications controller, a reel, a display, and at least one peripheral or interface to receive user input. In examples, embodiments may receive first user input comprising a wager to initiate a pachislot gaming event. The communications controller may randomly determine a target symbol and an event outcome. During a reel spin, second user input may initiate a stopping the plurality of reels. The set of symbols on the stopped reel may be configured to match the randomly determined event outcome and used to resolve the wager.

### CROSS REFERENCE TO RELATED APPLICATIONS

The present application claims the benefit of U.S. Provisional Patent Application No 63/703,460, filed October 4, 2024, the entirety of which is incorporated by reference herein.

### TECHNICAL FIELD

The present disclosure relates to gaming apparatus and more particularly to pachislot gaming apparatuses or systems and methods for using the same.

### BACKGROUND

Pachislot machines are popular gaming devices in which players attempt to match a series of symbols, which are often spinning on a wheel. Similar to slot machines, a player may hit a lever to spin a reel and hit a button to stop the reels. If the player matches certain symbols along a payline, they can win a prize such as credits, a free spin, or other bonuses.

Traditional pachislot machines are fully mechanical machines, with physical reels and levers to start and stop reel spins and vary a spin speed. In such devices, machine maintenance can be time-consuming. It can also be challenging to ensure consistency between machines, as slight mechanical variations and errors can significantly affect a difficulty level and win rate associated with a machine.

Pachislot is also traditionally considered a skill-based game, as players can control aspects of a reel spin, such as the timing of stopping reels and a player-operated lever, to start or stop reels. Players more familiar with a particular machine’s operational characteristics and idiosyncrasies may be able to increase their win rate. This can create challenges for a gaming hall to determine appropriate prizes and payouts, as win rates are not necessarily random, consistent, or predictable.

As the gaming industry becomes increasingly competitive, player experience and gameplay experience also become increasingly important. Familiarity with a game type or machine can cause player interest and engagement to stagnate or decrease over time. Further, many gaming jurisdictions and regulations require gaming machines to operate randomly or according to a particular payout scheme. Due to the physical mechanics and manual operation of the pachislot machine, operating with the required consistency may be difficult and limit where and how pachislot machines are operated. Thus, there is a need for innovations to enhance the gameplay experience and operational aspects of pachislot machines.

### SUMMARY

Pachislot gaming systems and apparatuses are disclosed. In an embodiment, a communications controller may be installed in a pachislot gaming machine. The communications controller is configured to execute a pachislot gaming event according to a randomly determined outcome, and exchange gaming information about the gaming event with a remote gaming system monitoring the pachislot gaming event and player activity at the pachislot gaming machine.

In examples the communications controller executes the pachislot gaming event and the randomly determined outcome in accordance with Class III gaming requirements. The communications controller may spin reels and control a reel stop according to a randomly determined outcome, with different outcomes having respective probabilities in accordance with a paytable. The paytable may be provided to the communications controller by the remote gaming system. The randomly determined outcome may be determined by a random number generator. The random number generator may determine at least one of: a reel speed, a reel stop timing, and a spin outcome.

The communications controller may also track, via one or more peripherals of the pachislot gaming machine game data associated with the pachislot gaming event. The game data may include at least one of: a current prize, total prize won, a total number of games played, and a summary associated with of a last set of spins.

According to examples, embodiment may receive, at an interactive interface connected to a pachislot gaming machine, first user input comprising a wager to initiate a pachislot gaming event. The pachislot gaming machine may include a plurality of reels, a display, and a communications controller in remote communication with a remote management system tracking gaming operations. Aspects may randomly determine, by the communications controller, a target symbol and an event outcome. The plurality of reels may be spun. The plurality of reels may be stopped after second user input received at a peripheral associated with the pachislot gaming machine. A set of symbols shown on the stopped reel matches the event outcome. The wager may then be resolved based on the event outcome.

Additionally, the communications controller may generate graphics associated with the randomly determined outcome on a display associated with the pachislot gaming machine. The pachislot gaming machine may also be operated to eliminate player influence on an outcome of the pachislot gaming event. In examples, the communications controller operates at least one of: a lever or handle associated with the pachislot machine, a reel spin speed, a reel stop timing, and a reel outcome.

### BRIEF DESCRIPTION OF THE DRAWINGS

FIG. 1 illustrates an example pachislot machine in accordance with an embodiment.

FIG. 2 illustrates an example communications architecture in accordance with an embodiment.

FIG. 3A illustrates an example gaming cabinet in accordance with an embodiment.

FIG. 3B illustrates another example gaming cabinet in accordance with an embodiment.

FIG. 3C illustrates another example gaming cabinet in accordance with an embodiment.

FIG. 3D illustrates another example gaming cabinet in accordance with an embodiment.

FIG. 4 illustrates a game flow in accordance with an embodiment.

FIG. 5 illustrates another game flow in accordance with an embodiment.

FIG. 6 illustrates a flow chart in accordance with an embodiment.

FIG. 7 illustrates a block diagram of an embodiment of a computer system.

### DETAILED DESCRIPTION OF ILLUSTRATIVE EMBODIMENTS

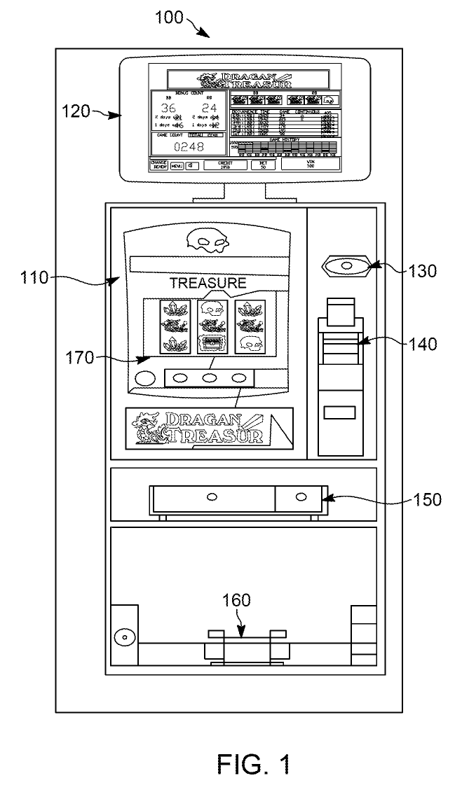

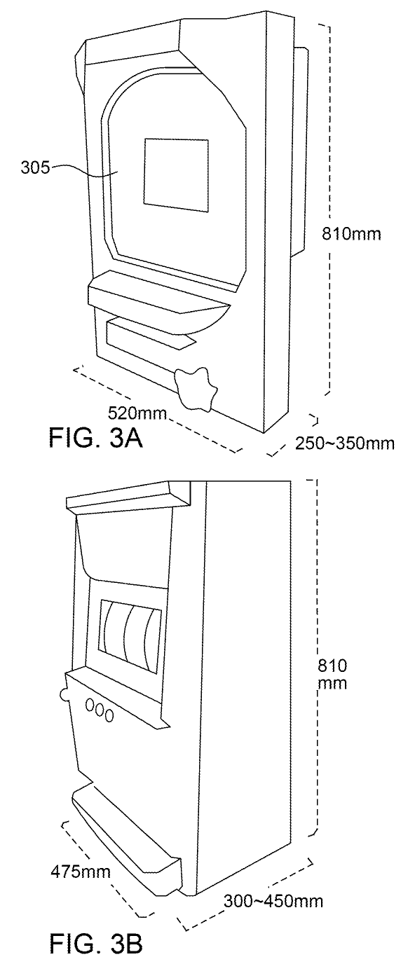

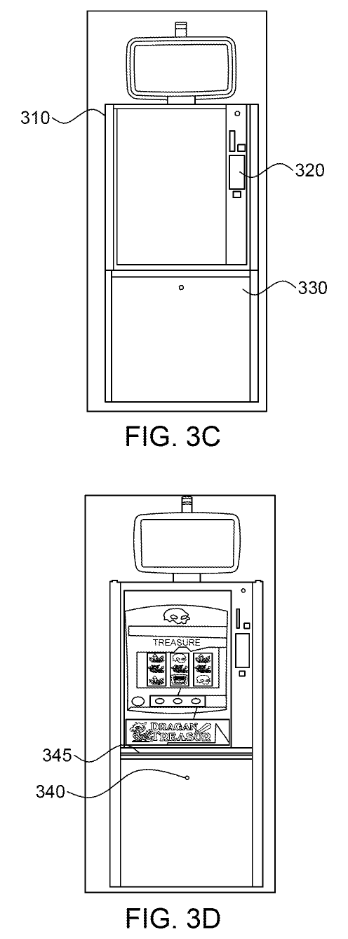

FIG. 1 illustrates an example pachislot machine 100. In the illustrated example, the pachislot machine includes a reel section 110, a display 120, a speaker 130, a payment unit 140, a communications controller 150, a power management unit 160, and a peripheral 170. The pachislot machine may be provided in a cabinet, such as a standalone cabinet (see, e.g. FIGS. 3A-D), which can be easily moved and arranged in a gaming hall or other gaming location.

The reel section 110 may provide a mechanical reel, a virtual reel, (e.g., on a monitor or other display device), or, in some examples, a combination of physical and electronic features (e.g., hybrid mechanical and virtual reels). The reel section 110 may further include graphics, animations, and other gameplay indicators, such as payline information, symbol information, bonus amounts, and the like.

The display 120 may provide real-time gaming information, such as reel spins, current wagers, bonuses, prizes won, and other animations, graphics, colors, sounds, and notification for different aspects of gameplay. The display 120 may provide graphics in response to a gaming event occurring during a round of play, such as a win graphic or animation in response to a win. The display may also provide information about the pachislot machine, such as a game name, a current jackpot, bonus information, and the like. In examples, the display is provided on a top portion of the pachislot machine 100. The display 120 may be positioned to be easily viewable to the player and others around the machine. In such a position, the display 120 may help to attract players and increase interest by both current and potential players. In some examples, the gaming display 120 is a primary monitor or an additional monitor associated with the pachislot machine 100. The gaming display may also include a touch panel or other interface to receive user input.

A speaker 130 may be provided on the pachislot machine 100. The speaker 130 may provide sound effects before, during, and after a gaming event. In some examples, the speaker 130 provides reel spin noises especially when virtual reels are spun. During bonus games and other events, the speaker 130 may provide a unique sound clip to indicate the bonus game or particular event. The speaker 130 may also provide sound effects for the display 120 to further attract player, attention, excitement, and interest.

The payment unit 140 may include a bill validator and a card unit. The card unit can read, for example, player cards, payment cards, casino cards, loyalty cards, and the like. The payment unit 140 can receive and send accepted bill information to the pachislot machine 100 to control the balance, which may be provided on a display. The payment unit 140 may also record winnings and loss information to a card (e.g., a player card) or on a printed card issued to the player when the player cashes out. The payment information may also be sent to a backend computing system (e.g., backend computing system 220) for additional recordation and bookkeeping. In examples, a player can make a selection to “Cash Out” when they no longer wish to continue playing and the value associated with any remaining credits may be provided to the player or to a player account via the payment unit 140. As discussed herein, the payment unit 140 may print or generate a card to the player, or otherwise update a player card or player account. The payment unit 140 may operate, for example, a printers, input slot, an additional display, an audit meter, game meter, credit meter, and the like. The payment unit 140 may also provide information to the communications controller 150, such as ticket in, bill in, error status, event status, ticket out, test, and a request command. The communications controller 150 may also provide information to the payment unit such as a ticket out, a test, and a request command.

The communications controller 150 may be connected to a game processor and wirelessly communicate with a backend computing system. Thus the communications controller 150 may utilize an existing game platform (e.g., game processor) associated with a pachislot machine and enable randomized gaming outcomes according to particular gaming requirements, such as Class III machines. The communications controller 150 may initiate and manage a pachislot gaming event. The communications controller 150 may providing gaming data, including sounds, images, feedback, and the like to the pachislot machine 100 and it’s the display 120. In examples, at least one of the display 120 and the reel section 110 may provide information to the communications controller 150, regarding the gaming event and information received from a user (e.g., player input via the reel section 110, display 120, or other peripheral). The communications controller 150 may also provide gaming information to the display 120, such as a current game status, winning symbols, winning paylines, wager information, outcome information, and other general information such as a wager denomination, a credit meter amount, a bet amount, a win amount, a game count, a bonus count, a help screen graphic, audit metering information, audit event information, and game recall information.

The peripheral 170 may be a device operated by a player to effect one or more gaming actions to initiate a game or during game play, such as a handle, a button, user interface, or other player input device, In examples, the peripheral 170 may be located in an area for easy operation by a player, such as on the reel section 110, beneath the reel section 110, on a ledge of the pachislot machine cabinet, or other easily reachable an accessible area of the pachislot machine 100.

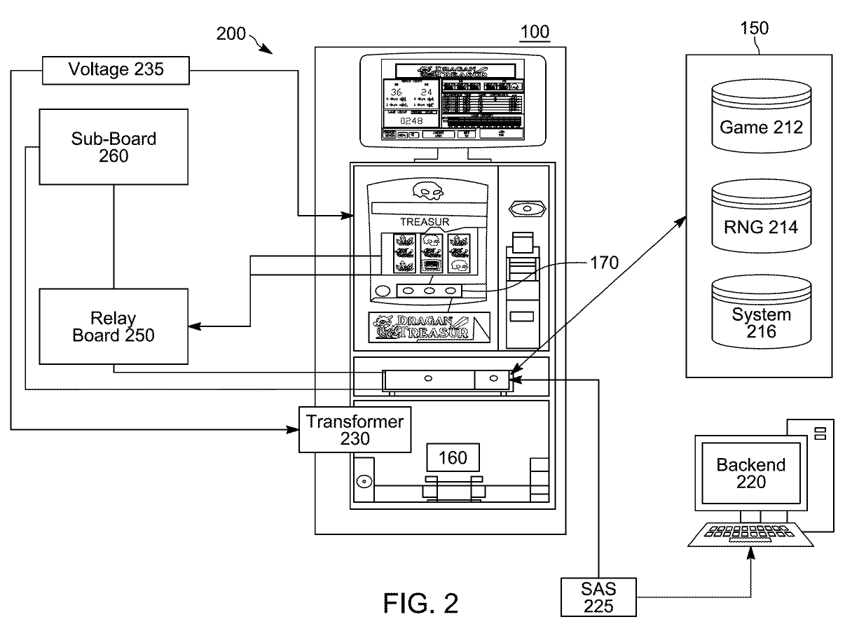

FIG. 2 illustrates an example communications architecture 200 in accordance with various embodiments. The communications architecture may enable the pachislot machine 100 to be a Class III casino machine. Class III machines are related to slot machines, and other game offerings resembling traditional casino games, including but not limited to video poker, roulette, blackjack, craps, and the like. Class III machines utilize a random number generator to determine play outcomes, ensure fairness, and results based on chance. As applied to pachislot machines, the communications architecture enables the traditionally skill-based game to become a Class III machine.

The pachislot machine 100 may be housed in a gaming cabinet see (e.g., FIGS. 3A-D One or more of the components illustrated in FIG. 2 may be housing in the gaming cabinet. In some examples, one or more components may be adjacent to or connected, e.g., electronically, physically, wirelessly, etc., to communicate with each other.

As discussed with respect to FIG. 1, the pachislot machine 100 may include a communications controller 150, which is in communication with a backend computing system 220. The communications controller 150 may include, for example, game software 212, a random number generator 214, and a system software 216. The game software 212 may provide math, paytables, and other numerical data for executing pachislot games with randomized outcomes. The random number generate 214 may assist in determining outcomes for gaming operations. The system software 216 may interface with existing gaming software operating on the pachislot machine and assist with integration of the communications controller 150 onto existing machines for seamless operation. In examples, the communications controller may be installed onto an existing pachislot machine, e.g., as a plugin on an existing machine), and the communications controller 150 may, in connection with a gaming processor, operate gaming events. The software on the communications controller 150 may enable consistent gaming operations with randomly determined outcomes, according to a payable. The communications controller 150 may receive game updates (e.g., updated paytables, probabilities, graphics, sounds, game-related features, etc.) from a remote system, such as the backend computing system 220, to keep the machine up to date and to update game flows, as needed.

The backend computing system 220 may track one or more gaming machines on a casino floor and connect, for example, to a casino or a gaming location’s central monitoring system. The backend system 220 may track, for example, credits in, credits out, credits played, gaming counters, gaming meters, wins, losses, total games played, gaming statistics, errors, alerts, malfunctions, player activities, rewards, and other gaming information associated with the machine. Such communications between components may occur in real-time to provide a live look at gaming activity at one or more gaming machines, including pachislot machine 100.

In order to track such metrics, the communications controller 150 may provide the primary communication and information relay between a gaming processor of the pachislot machine 100 and the backend computing system 220. The communications controller 150 may include one or more processors and memory storing instructions thereon to execute operations to control communications to and from various devices within the gaming machine 100. The communications controller 150 therefore serves as a communication device to process and exchange information between the pachislot machine 100 and its various components (e.g., display 120, peripherals, etc.) and the backend system 220.

In examples, actions and information occurring at the pachislot machine 100 are received, compiled, and processed at the communications controller 150, which may communicate directly with a gaming system (e.g., Slot Accounting System (SAS) 225) and the backend computing system 220. In examples, the SAS 225 manages and communicates gaming data between a communication controller 150, the pachislot machine 100, any associated peripherals, and the backend computing system 220. Together, such features help to enable game tracking, player tracking, accounting information, monitoring, and compliance during operation of gaming events.

In various examples, the communications controller 150 may initiate a gaming event and provide gaming data, including sounds, images, feedback, and the like to the pachislot machine 100 and the display 120. The gaming display 120 may be a primary monitor or an additional monitor associated with the pachislot machine 100. The gaming display 120 may also include a touch panel or other interface to receive user input. In examples, the display 120 may provide information to the communications controller 150, such as a display disconnect, a touch panel disconnect, and any information received from a user (e.g., player input). The communications controller 150 may provide information to the at least one of the display 120 and the reel section 110 and such information may include but is not limited to a denomination, a credit meter amount, a bet amount, a win amount, a game count, a bonus count, a help screen graphic, audit metering information, audit event information, and game recall information.

The communications controller 150 may further provide features and functions not previously realized on traditional pachislot machines. For example, the communications controller 150 may interact with and operate with components to assist and/or operate a payment unit (e.g., payment unit 140), bill validator, a printer, an audit meter, game screens, help screens, error and event handling operations, game settings, credit management, wins, payouts, wagers/bets, game tracking, and player tracking. Additional operations that the communications controller 150 may track and communicate include one or more of: an animation or a movie event (e.g., provided on display 120), active credit information, host information, a spin start, an I/O test, output information, reel sensor determinations (e.g., magnetic sensor(s) used in the pachislot machine 100), and a cabinet door open/ close.

FIG. 2 also illustrates an electronics relay, in accordance with embodiments. In some examples, in order to execute gaming operations based on software included on the communications controller 150, the power management unit 160 may need to electronically manage one or more components of the pachislot gaming machine. In examples where the communications controller 150 is retrofitted onto an existing machine, the power management unit 160 may serve to enable operation of one or more electronic components, such as the reel section 110, display 120, the payment unit 140, among others. The power management unit may include a transformer 230 in connection with a voltage converter 235 operating the reel section 110. As discussed herein the reel section may be an electronic reel, e.g., displaying virtual reel spins, a mechanical reel e.g., with physical reels, or a combination of electronic and mechanical devices. The transformer 230 and voltage converter 235 ensures appropriate power is going towards each section for their operation. The reel section 110 may also include one or more peripherals 170 which may be electronically connected.

A relay board 250 and a sub-board 260 may provide input/output information from the reel section 110 and one or more peripherals 170. The relay board 250 may interface with one or more peripherals, such as a bet input peripheral, a lever, a reel stop peripheral. Such information may be provided to sub-board 260 to process, for example, information related to various, button, lever, and reel operations, as well as processing gaming outcomes.

In various embodiments, the communications controller 150 may provide, to the relay board 250, information related to one or more of a peripheral input (e.g., a button or lever input), payment unit operations (e.g., bet/credit/coin in determinations), a game outcome, error status, a clear random access memory (RAM) command, and setting information. The communications controller 150 may also provide, to the sub-bard 260, information related to one or more of a reel position, a physical reel outcome, payment unit operations, (e.g., bet/credit/coin out determinations), a door event, an error, a game count, a game start, a game end, and game backup information.

In an example, a peripheral 170 may be a lever to start or stop a reel spin. The physical movement of the lever may activate a sensor to generate an electronic signal that is provided to the relay board 250 and the sub-board to the communications controller 150 to determine a resulting action. In some examples, the peripheral 170 is a button. In additional examples, a force, speed, or pressure exerted on the peripheral, may appear to influence a reel spin start or stopping speed. For example, a forceful hit of the stop button may appear to stop the reels faster, whereas a softer hit may cause the reels to spin longer and appear to slop more slowly. In various examples, the force of the input at the peripheral may generate a signal to the communications controller 150. However, in example embodiments, the operation of the peripheral, including the force or the speed of activation of the peripheral has no actual effect on the outcome of the reel spin. Such reel spin outcomes may occur according to a randomly generated outcome, according to a paytable, as determined by the communications controller 150. Accordingly, games can therefore remain fair and random while providing the user with the experience and excitement associated with of a skills-based game.

FIGS. 3A-D illustrate example gaming cabinets on which pachislot machines (e.g., pachislot machine 100) may be installed. The cabinets may be standalone cabinets having a common footprint, similar to other gaming cabinets, such as slot gaming cabinets. FIG. 3A shows an example with a recessed display area 305 on which the game may be installed. The cabinet has a length of 520 mm a width of 250-350 mm, and a height of 810 mm. FIG. 3B illustrates a cabinet similar to a slot machine and sized similarly. In the example, the length may be 475 mm, the width may be 300-450 mm, and the height may be 810 mm. It should be appreciated that the depicted cabinets are merely examples, and cabinet sizes may be larger or smaller in any dimensions, to accommodate appropriate hardware, machinery, and any other design considerations.

FIGS. 3C-D illustrates additional examples of a gaming cabinet for pachislot games. In FIG. 3C, a top portion 310 may be hollow to hold the pachislot machine 100 and any associated displays. Panel 320 may hold at least one of a peripheral devices and a control panel for gaming operations. In some examples, panel 320 contains the printer, the control panel, and a payment unit (e.g., payment unit 140). The control panel may include buttons for Return (e.g., return card or cashout with the balance and information about the number of winning reels and paylines, Balance (e.g., showing a balance of a card or an amount available for play on the machine), Stop (e.g., to initiate a stop of one or more reels), and Spin (e.g., to initiate a reel spin).

In a bottom section 330, additional hardware to operate the gaming unit may be contained. In examples, the bottom section may include the communications controller (e.g., communications controller 210), wiring, and other hardware associated with gaming operations and communications. The bottom section 330 may include a security door 340 to secure any contained components and prevent damage, cheating, and general access to the components by a player or unauthorized individual. In some examples, the reels may have a cover 345, such as a blank plate to prevent players from touching, removing, or accessing the reels and other components of the pachislot machine.

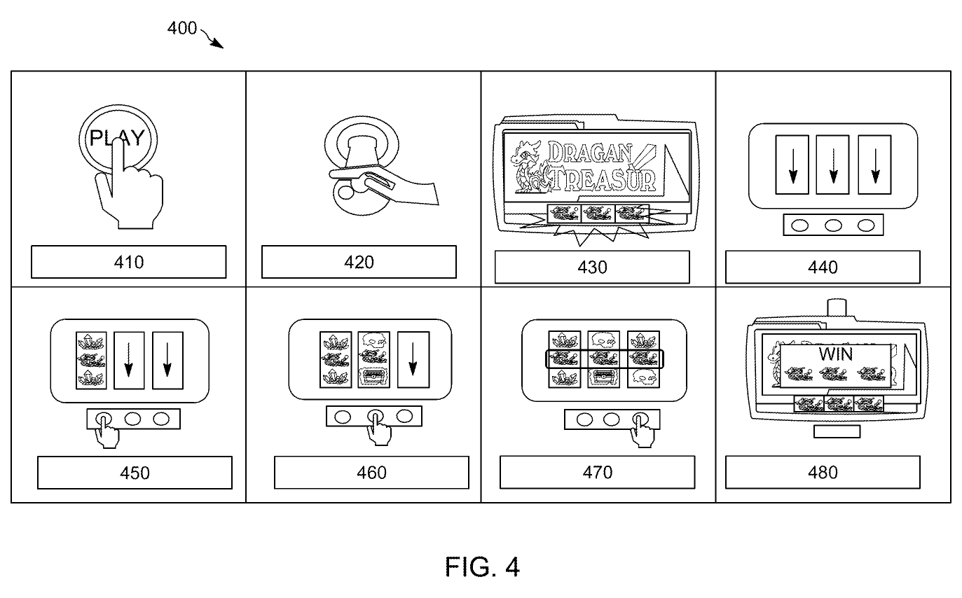

FIG. 4 illustrates a game flow 400 in accordance with embodiments. In pachislot gaming events, players use dynamic vision skills to align symbols on reels, and attempt to stop the reels to align certain symbol combinations. In the example of FIG. 4, a player may place a bet 410 using one or more input methods on a pachislot machine. In some examples, the bet may be placed via a button, an operation of an interactive interface, such as a touch screen, an operation of a lever, or an operation of another peripheral of the pachislot machine. To initiate a game start 420, a player may hit a peripheral, such as a lever, to begin the game.

When the game begins, a target symbol appears 430. The target symbol may appear on a display (e.g., display 120), and the target symbol may be selected randomly from a set of potential target symbols. In examples, target symbol represents the symbol to be selected on the reel, in order to win a prize, such as credits, a jackpot, a bonus, or an additional spin. Certain symbols may represent a particular prize or outcome. For example, a fruit symbol, such as a cherry or a watermelon may indicate a bonus win. Symbols may have a different probabilities for being selected as the target symbol. For example a first symbol may have a 1/100 chance of being selected and a second symbol may have a 1/80 chance of being selected. Once selected as the target symbol, there may be a separate probability of those symbols aligning, and thus winning, via the reel spin. For example, a selected target symbol may have a 10% chance of winning, whereas another target symbol may have an 80% chance of winning.

The player may activate a peripheral, such as a button or a lever to initiate a stop of the first reel 440. After the first reel has been stopped, the player may activate the peripheral to stop a second reel 460 similarly, and the subsequently stop the third reel 470.

In examples, the outcome of the first reel – and all reels – has already been determined, for example, when the target symbol was determined. The target symbol and the outcomes for each reel may have already been predetermined e.g., by the communications controller 150 and its random number generator. The outcomes of each reel may have been determined by a paytable associated with the gaming event being operated by the communications controller.

In examples, the player selection at the reel section 110 merely initiates the display of the already-determined reel outcome. In other words, the player selection may initiate the first reel slowing to a stop onto the determined outcome. The player selection has no effect or influence on the reel outcome. However, the player selection may give an appearance that the player has some influence on the outcome.

In other examples, the player selection at the reel section 110 does influence the selection of one or more reels. For example, a first and second reel may be configured to stop based on a timing of the player selection. Thus, the player may use dynamic vision and skill to try to stop on a desired symbol. At least one reel, e.g., the third reel may be configured to stop to effect the event outcome, i.e., win or lose. Thus, the player selection has no influence on the final position of the third reel.

In an example, a target symbol may be a cherry. The player may use dynamic vision and skill to stop the first two reels on a cherry. The third reel, regardless of a timing of when the player makes a selection, will land on a cherry if the event outcome was deemed to be a win. If the event outcome was deemed to be a lose, the third reel will not land on a cherry, regardless of a timing of a player selection.

In some examples, if an event outcome is determined to be a win, the player must be able to stop the first two reels at a proper timing, e.g., based on skill, in order to win the event. In such examples, if a player does not skillfully stop the first two reels on the target symbol, then the win outcome will not be satisfied, even though the random determination designated the round as a win. Thus a win may require both the random determination of a win, and the player’s skill to correctly match the target symbol on at least one of the reels.

Although only three reels are discussed in this example, more or less reels may be provided on the pachislot machine. In various examples, one or more buttons may be provided to initiate the reel spins and stops. For example, a separate button may be provided for each reel. A lever may be provided to initiate the reel spin. In other examples, a single button or level is used for all start and stop operations.

Once all the reels have been stopped, the display provides an outcome notification. In some examples, a graphic, animation, video, sound effect, or a combination of the above may be provided on the display. The outcome notification may indicate for example, a win, a loss, a bonus, a jackpot, and additional spin, or other message, in accordance with the gaming event.

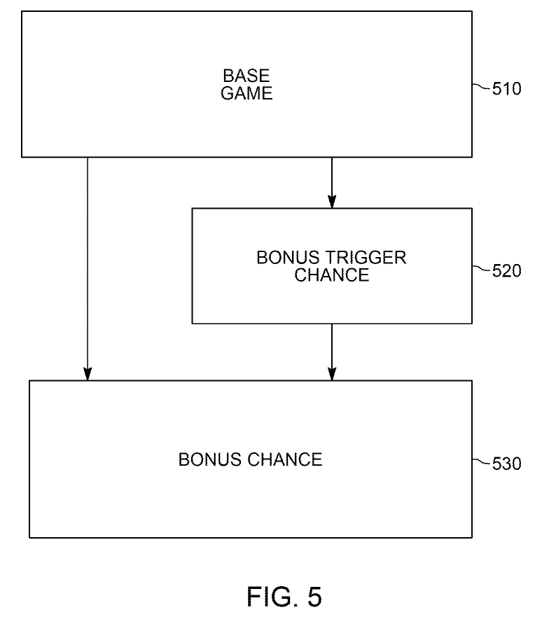

FIG. 5 illustrates an example game flow in accordance with various embodiments discussed herein. In the example, a pachislot machine may operate a base game 510. The base game may be associated with a first paytable, and optionally, a first gaming mode. A bonus trigger chance 520 may be initiated to provide the player a bonus chance 530, which if won, may be a larger payout, additional spins, or another prize. The bonus trigger chance 520 may be entered if a player did not hit a designated bonus symbol combination on the reel. The bonus chance 530 mode may be entered when a player makes the bonus symbol combination in either the base game 510 or the bonus trigger chance 520. In some examples, the bonus trigger chance 520 and the bonus chance 530 will continue to increase until a bonus is hit.

In the base game 510, a particular symbol e.g., a watermelon, may be selected as the winning symbol to initiate the bonus trigger chance 520. In the bonus trigger chance 520, a second symbol, e.g., a cherry, may be selected as the target symbol, which if won, initiates the bonus chance 530. The bonus chance 530 may provide the player a chance to win a bonus, which may be, for example, a prize, jackpot, additional spin, a payout, or another option, depending on the particular. After the bonus chance occurs, the game flow may transition back to the base game 510.

As noted herein, the pachislot gaming machine may operate in different gaming modes. The different gaming modes may have different paytables, symbols, jackpots, prizes, and payouts. In some examples, the base game 510 represents a first gaming mode, the bonus trigger chance 520 represents a second gaming mode, and the bonus chance 530 represents a third gaming mode.

In some examples, different gaming modes may be initiated based on an amount that a player has played, or a total number of games played on the machine. In an example, a first mode may be a base mode (e.g., base game 510) wherein the chance of winning a bonus is low, e.g., 10%. The gaming machine may transition into a second mode, with a different bonus win probability, e.g., 15%, a third mode, e.g., with a 50% bonus win probability, and a fourth mode with a high bonus win probability, e.g., 80%. Such modes may be activated, for example, based on a side bet an amount of money played by a user, or a time or amount of bets placed on a particular machine. In each mode, gaming operations may occur as discussed herein, but with different paytables, payout probabilities, and optionally, different payout symbols.

In an example, a game mode may be changed based on a trigger of a certain winning symbol. For example, a game may operate in Mode A until a first symbol, e.g., a watermelon, wins. The winning first symbol initiates Mode B (e.g., bonus trigger chance 520), with different win probabilities, until a second symbol wins. The second symbol may be the same or different than the first symbol. In an example, the second symbol, e.g., a cherry initiates a Mode C (e.g., bonus chance 530). In some examples, if the second symbol doesn’t win, the mode will revert back to Mode A, where the mode chance process restarts.

If Mode C is initiated, a third symbol, e.g., another cherry, may initiate a Mode D. In Mode D, a winning symbol may initiate a bonus. Any other symbols may change the mode back to Mode A, B, or C, depending on the game flow. Game mode changes may be factored into an overall paytable scheme for the pachislot gaming machine, to define probabilities, payouts, and return to player values for the gaming machine and all of the possible modes. Gaming modes may provide excitement, variety, and entertainment to players, who may want to experience different game modes. Game modes may also have different animations sounds story lines and symbols associated with the game mode thus encouraging additional play, so that players can see the various possibilities and game lines.

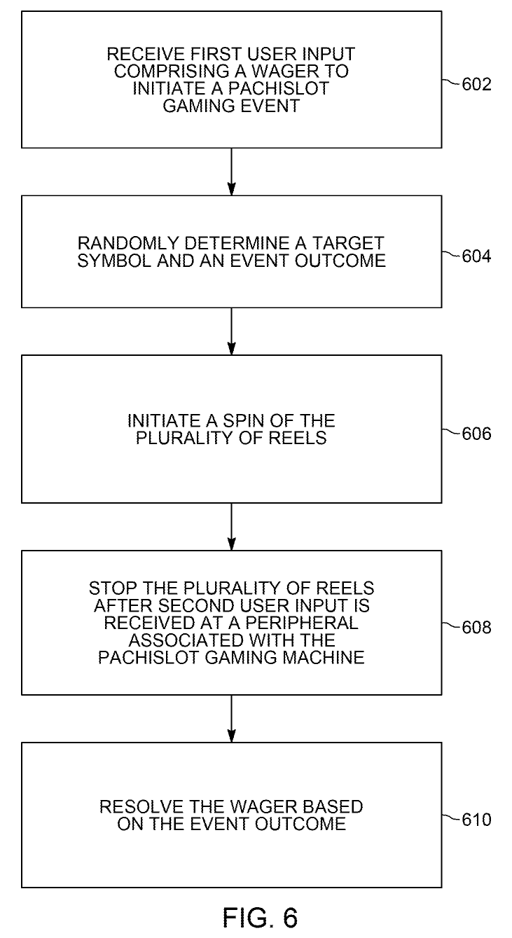

FIG. 6 illustrates a flow chart related to a pachislot gaming system and related operations. Various embodiments may include a pachislot gaming controller having at least one processor, and at least one memory communicatively coupled to the at least one processor and comprising computer-readable instructions can cause the at least one processor to perform various operations, such as operations 602-610. In some examples, the pachislot gaming controller establishes a connection with a game processor on a pachislot gaming machine.

The pachislot gaming machine may include a reel display within an enclosed section, a gaming display, one or more user controls, a gaming processor, and a communications controller. In some examples, the pachislot gaming machine further includes a cabinet housing the communications controller, the reel display, and the gaming display. The communications controller may be secured within an interior portion of the cabinet, such as a locked interior portion. The communications controller may be in remote communication with a remote management system, which may track gaming operations. The pachislot gaming machine may also include a payment unit configured to receive at least one of: cash, a payment card, a token, and a player card. The communications controller may establish a communication with the payment unit associated to resolve a wager.

At block, 602, aspects may receive first user input comprising a wager to initiate a pachislot gaming event.

At block 604, aspects may randomly determine a target symbol and an event outcome. The target symbol may be provided on a display device associated with the gaming machine. The display may be a monitor mounted to or included within the gaming cabinet. The display may be an interactive interface. The display of the target symbol provides notice to the player regarding which symbol to try to match on the reels.

At block 606, aspects may initiate a spin of the plurality of reels. The plurality of reels may include, three, four, five, or more reels. The reel spin may initiate spinning of a set of physical reels. In other examples, the spinning reels may be virtual reels, for example, a video, animation, or other reel graphic on a reel display.

At block 608, aspects may stop the plurality of reels after second user input is received at a peripheral associated with the pachislot gaming machine. In examples, the timing of the second user input does not affect the event outcome. The second user input may include a first selection to stop a first reel, a second selection to stop a second reel, and a third selection to stop a third reel. The second user input may also include a first selection that enables player control of a stop position of a first reel, and a second selection that does not influence a stop position of the second reel. The stop position of the second reel is based on the event outcome. According to various examples, the player input may control the reel stop timing for one or more reels in the plurality of reels, and at least one reel in the plurality of reels is configured to stop, independent of the player input, to ensure that the event outcome occurs.

For example, in a machine having three reels, the stop timing of the first and second reel may be under the player’s control. A skilled player may be able to stop the reels at a desired position, using dynamic vision and experience with the game. The third reel may be configured to stop at a time after the machine receives a player input to stop the third reel, however the symbol shown on the final position third reel may be based on the event outcome, not the player’s control. Thus, the event outcome e.g., win or lose, will be displayed regardless of they player’s skill and input on the machine. However, since the user will be able to control the stop of the first two reels, the player may still feel in control of the came and experience excitement and interest in playing a skills-based game.

At block 610, aspects may resolve the wager based on the event outcome. Resolving the wager may include awarding at least one of a credit value, a bonus, a jackpot, and an additional reel spin. In some examples, the gaming event is associated with a first game mode, and the event outcome may initiate a second game mode for a next round of play. The second game mode may include at least one of: a different set of symbols, a different payout, a bonus round, and a different paytable. The second game mode may be automatically initiated based on the random determination of at least one of the target symbol and the event outcome. For example, selection of a particular target symbol or other symbol on the reel may trigger the game mode change.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

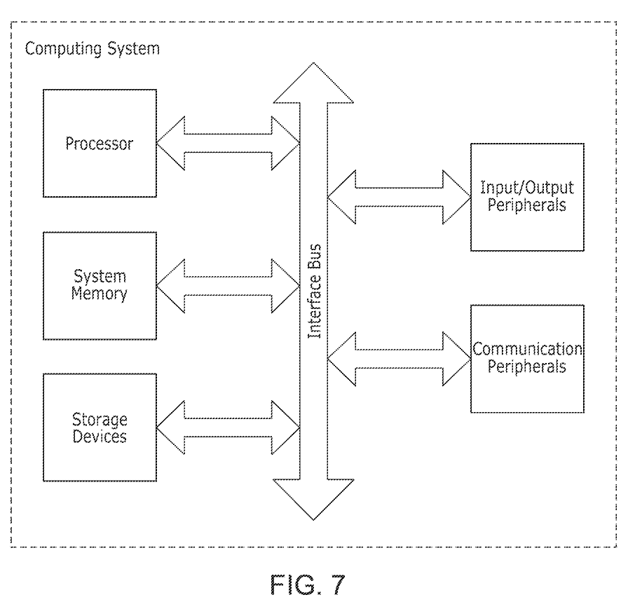

Some of the techniques described above can be implemented on a computing device associated with a gaming device (e.g., a roulette mechanism), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, some of the techniques may be distributed between the computing device(s) and the controller(s). FIG. 7 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the shooter selection and console mirroring, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration, RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems, (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a WiFi/ broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

In an embodiment, a method for pachislot gaming, comprising: receiving, at an interactive interface connected to a pachislot gaming machine, first user input comprising a wager to initiate a pachislot gaming event, wherein the paschislot gaming machine comprises a plurality of reels, a display, and a communications controller in remote communication with a remote management system tracking gaming operations; randomly determining, by the communications controller, a target symbol and an event outcome; initiating a spin of the plurality of reels; stopping the plurality of reels after second user input is received at a peripheral associated with the pachislot gaming machine, wherein a set of symbols shown on the stopped reel matches the event outcome; and resolving the wager based on the event outcome.

In an embodiment, wherein the second user input comprises a first selection to stop a first reel, a second selection to stop a second reel, and a third selection to stop a third reel.

In an embodiment, wherein the second user input comprises a first selection that enables player control of a stop position of a first reel, and a second selection that does not influence a stop position of the second reel, wherein the stop position of the second reel is based on the event outcome.

In an embodiment, wherein the timing associated with the second user input does not affect the event outcome.

In an embodiment, wherein initiating the reel spin comprises independently spinning a set of physical reels.

In an embodiment, wherein initiating the reel spin comprises generating a virtual reel to spin on a reel display.

In an embodiment, further comprising displaying the target symbol at the display.

In an embodiment, wherein resolving the wager comprises: awarding at least one of a credit value, a bonus, a jackpot, and an additional reel spin.

In an embodiment, wherein the pachislot gaming event is associated with a first game mode, and further comprising, applying a second game mode during a next round of play.

In an embodiment, wherein the second game mode comprises at least one of: a different set of symbols, a different payout, a bonus round, and a different paytable.

In an embodiment, wherein the second game mode is automatically initiated based on the random determination of at least one of the target symbol and the event outcome.

In an embodiment, a pachislot gaming system comprising: at least one processor: and at least one memory communicatively coupled to the at least one processor and comprising computer-readable instructions that upon execution by the at least one processor cause the at least one processor to perform operations comprising: receiving , at an interactive interface connected to a pachislot gaming machine, first user input comprising a wager to initiate a pachislot gaming event, wherein the pachislot gaming machine comprises a reel, a display, and a communications controller: randomly determining, by the communications controller, a target symbol and an event outcome: initiating a reel spin: stopping the reel at a timing after second user input is received at a peripheral associated with the pachislot gaming machine, wherein a set of symbols shown on the stopped reel matches the event outcome: and resolving the wager based on the event outcome.

In an embodiment, wherein the second user input comprises a first selection that enables player control of a stop position of a first reel, and a second selection that does not influence a stop position of the second reel, wherein the stop position of the second reel is based on the event outcome.

In an embodiment, wherein initiating the reel spin comprises at least one of: independently spinning a set of physical reels and generating a virtual reel to spin on a reel display.

In an embodiment, wherein the pachislot gaming event is associated with a first game mode, and further comprising, applying a second game mode during a next round of play, wherein the second game mode comprises at least one of: a different set of symbols, a different payout, a bonus round, and a different paytable.

In an embodiment, wherein the timing associated with the second user input does not affect the event outcome.

In an embodiment, wherein the communications controller is in the remote communication with a remote management system tracking gaming operations and outcomes..

In an embodiment, a non-transitory computer readable medium comprising computer-executable instructions, which when executed cause: receiving, at an interactive interface connected to a pachislot gaming machine, first user input comprising a wager to initiate a pachislot gaming event, wherein the pachislot gaming machine comprises a reel ,a display, and a communications controller in remote communication with a remote management system tracking gaming operations; randomly determining, by the communications controller, a target symbol and an event outcome; initiating a reel spin; stopping the reel at a timing after second user input is received at a peripheral associated with the pachislot gaming machine, wherein a set of symbols shown on the stopped reel matches the event outcome; and resolving the wager based on the event outcome.

In an embodiment, wherein the second user input comprises a first selection that enables player control of a stop position of a first reel, and a second selection that does not influence a stop position of the second reel, wherein the stop position of the second reel is based on the event outcome.

In an embodiment, wherein the timing associated with the second user input does not affect the event outcome.

In an embodiment, a system for operating a pachislot gaming event, comprising: a communications controller installed in a pachislot gaming machine, wherein the communications controller is configured to: execute a pachislot gaming event according to a randomly determined outcome; and exchange gaming information about the gaming event with a remote gaming system monitoring the pachislot gaming event and player activity at the pachislot gaming machine.

In an embodiment, wherein the pachislot gaming machine comprises a reel section, a display providing game event information and at least one peripheral for receiving player input for stopping a reel during the pachislot gaming event.

In an embodiment, wherein the pachislot gaming machine comprises a cabinet supporting the communications controller, a reel display, display, and at least one peripheral.

In an embodiment, wherein the communications controller is secured within an interior portion of the cabinet.

In an embodiment, wherein the communications controller executes the pachislot gaming event and the randomly determined outcome in accordance with Class III gaming requirements.

In an embodiment, wherein the randomly determined outcome is based on a paytable associated with the communications controller.

In an embodiment, wherein the paytable is provided to the communications controller by the remote gaming system.

In an embodiment, wherein the communications controller is further configured to apply a random number generator is applied to determine a target symbol and an outcome for at least one reel during the pachislot gaming event.

In an embodiment, wherein the communications controller tracks, via one or more peripherals of the pachislot gaming machine, game data associated with the pachislot gaming event, wherein the game data comprises at least one of: a first reel outcome, a second reel outcome, a game mode, a total prize won, a total number of games played, and a summary associated with of a last set of pachislot games played at the machine.

In an embodiment, wherein the communications controller generates, on the display, graphics associated with the pachislot gaming event.

In an embodiment, wherein the communications controller operates the pachislot gaming machine to eliminate player influence on an outcome of the pachislot gaming event, wherein the outcome aligns with the randomly determined outcome.

As previously noted, the various features and processes described above may be used independently of one another or may be combined in various ways. All possible combinations and sub- combinations are intended to fall within the scope of this disclosure. In addition, certain method or process blocks may be omitted in some implementations. The methods and processes described herein are also not limited to any particular sequence and the blocks or states relating thereto can be performed in other sequences that are appropriate .For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, "can," "could," "might," "may," “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed:

1. A method for pachislot gaming, comprising:
receiving, at an interactive interface connected to a pachislot gaming machine, first user input comprising a wager to initiate a pachislot gaming event, wherein the pachislot gaming machine comprises a plurality of reels, a display, and a communications controller in remote communication with a remote management system tracking gaming operations;
randomly determining, by the communications controller, a target symbol and an event outcome;
initiating a spin of the plurality of reels;
stopping the plurality of reels at a timing after second user input is received at a peripheral associated with the pachislot gaming machine, wherein a set of symbols shown on the stopped plurality of reels matches the event outcome; and
resolving the wager based on the event outcome.

2. The method of claim 1, wherein the second user input comprises a first selection to stop a first reel, a second selection to stop a second reel, and a third selection to stop a third reel.

3. The method of claim 1, wherein the second user input comprises a first selection that enables player control of a stop position of a first reel, and a second selection that does not influence a stop position of a second reel, wherein the stop position of the second reel is based on the event outcome.

4. The method of claim 1, wherein a timing associated with the second user input does not affect the event outcome.

5. The method of claim 1, wherein initiating the spin of the plurality of reels comprises independently spinning a set of physical reels.

6. The method of claim 1, wherein initiating the spin of the plurality of reels comprises generating a virtual reel to spin on a reel display.

7. The method of claim 1, further comprising displaying the target symbol at the display.

8. The method of claim 1, wherein resolving the wager comprises: awarding at least one of a credit value, a bonus, a jackpot, and an additional reel spin.

9. The method of claim 1, wherein the pachislot gaming event is associated with a first game mode, and further comprising applying a second game mode during a next round of play.

10. The method of claim 9, wherein the second game mode comprises at least one of: a different set of symbols, a different payout, a bonus round, and a different paytable.

11. The method of claim 9, wherein the second game mode is automatically initiated based on a random determination of at least one of the target symbol and the event outcome.

12. A pachislot gaming system comprising:
at least one processor; and
at least one memory communicatively coupled to the at least one processor and comprising computer-readable instructions that upon execution by the at least one processor cause the at least one processor to perform operations comprising:
receiving, at an interactive interface connected to a pachislot gaming machine, first user input comprising a wager to initiate a pachislot gaming event, wherein the pachislot gaming machine comprises a reel, a display, and a communications controller;
randomly determining, by the communications controller, a target symbol and an event outcome;
initiating a reel spin;
stopping the reel at a timing after second user input is received at a peripheral associated with the pachislot gaming machine, wherein a set of symbols shown on the stopped reel matches the event outcome; and
resolving the wager based on the event outcome.

13. The pachislot gaming system of claim 12, wherein the second user input comprises a first selection that enables player control of a stop position of a first reel, and a second selection that does not influence a stop position of the second reel, wherein the stop position of the second reel is based on the event outcome.

14. The pachislot gaming system of claim 12, wherein initiating the reel spin comprises at least one of: independently spinning a set of physical reels and generating a virtual reel to spin on a reel display.

15. The pachislot gaming system of claim 12, wherein the pachislot gaming event is associated with a first game mode, and further comprising, applying a second game mode during a next round of play, wherein the second game mode comprises at least one of: a different set of symbols, a different payout, a bonus round, and a different paytable.

16. The pachislot gaming system of claim 12, wherein the timing associated with the second user input does not affect the event outcome.

17. The pachislot gaming system of claim 12, wherein the communications controller is in remote communication with a remote management system tracking gaming operations and outcomes.

18. A non-transitory computer readable medium comprising computer-executable instructions, which when executed cause:
receiving, at an interactive interface connected to a pachislot gaming machine, first user input comprising a wager to initiate a pachislot gaming event, wherein the pachislot gaming machine comprises a reel, a display, and a communications controller in remote communication with a remote management system tracking gaming operations;
randomly determining, by the communications controller, a target symbol and an event outcome;
initiating a reel spin;
stopping the reel at a timing after second user input is received at a peripheral associated with the pachislot gaming machine, wherein a set of symbols shown on the stopped reel matches the event outcome; and
resolving the wager based on the event outcome.

19. The non-transitory computer readable medium of claim 18, wherein the second user input comprises a first selection that enables player control of a stop position of a first reel, and a second selection that does not influence a stop position of the second reel, wherein the stop position of the second reel is based on the event outcome.

20. The non-transitory computer readable medium of claim 18, wherein the timing associated with the second user input does not affect the event outcome.
